(19) United States
(12) Patent Application Publication
(10) Pub. No.: US 2026/0217564 A1
(43) Pub. Date: Jul. 30, 2026

(54) METHOD OF PREPARING POSITIVE ELECTRODE ACTIVE MATERIAL PRECURSOR FOR LITHIUM SECONDARY BATTERY

(71) Applicant: POSCO FUTURE M CO., LTD., Pohang-si (KR)

(72) Inventors: Seung Un CHOI, Gumi-si (KR); Chang Hyun LEE, Gumi-si (KR); Gyeong Won NAM, Gumi-si (KR); Kwang Eun JUNG, Gumi-si (KR); Do Gak JEUNG, Gumi-si (KR); Jun Young PARK, Gumi-si (KR); Dong Young LEE, Gumi-si (KR); Hyun Seok JANG, Gumi-si (KR); Jeong Han KIM, Gumi-si (KR)

(21) Appl. No.: 19/159,060

(22) PCT Filed: Feb. 21, 2024
(86) PCT No.: PCT/KR2024/002282

§ 371 Date: Aug. 22, 2025

(30) Foreign Application Priority Data
Feb. 22, 2023 (KR) 10-2023-0023513

(51) Int. Cl. C01G 53/506; H01M 4/02; H01M 4/525

(52) U.S. Cl. CPC C01G 53/506; H01M 4/525; C01P 2004/03; C01P 2006/40; H01M 2004/028

(57) ABSTRACT

A method for manufacturing a positive electrode active material precursor for a lithium secondary battery is provided. The method comprises preparing a metal raw material, forming a reaction solution comprising the metal raw material, and coprecipitating a metal hydroxide precursor, wherein the reaction solution further comprises an additive, and wherein the additive comprises a colloidal flocculant. The method enables the manufacture of a positive electrode active material having a high level of microstructural orientation that facilitates ion diffusion throughout the electrode material and leads to batteries having significantly improved electrochemical properties.

### CROSS REFERENCE TO RELATED APPLICATION

This application is a National Stage Entry of International Patent Application No. PCT/KR2024/002282, filed on Feb. 21, 2024, which claims priority from and the benefit of Korean Patent Application No. 10-2023-0023513, filed on Feb. 22, 2023, which is hereby incorporated by reference for all purposes as if fully set forth herein.

### BACKGROUND

### Field

Embodiments of the invention relate generally to a method for manufacturing a positive electrode active material precursor for a lithium secondary battery.

### Discussion of the Background

With the development of technology and the increasing demand for electric vehicles, the demand for secondary batteries as an energy source has been rapidly increasing. Among such secondary batteries, lithium secondary batteries, which have high energy density and voltage, long cycle life, and low self-discharge rate, have been commercialized and are widely used.

As the positive electrode active material of lithium secondary batteries, lithium nickel cobalt manganese composite oxides are used, and among the constituent elements, cobalt provides a high operating voltage and influences rate characteristics.

However, positive electrode active materials with a high cobalt composition are expensive, which limits their use in large quantities as a power source in fields such as electric vehicles. In addition, due to the recent sharp increase in cobalt prices, there has been a trend to gradually reduce the cobalt content, thereby creating a need for solutions that can compensate for rate characteristics and lifespan. One such approach is the use of positive electrode active materials having uniform crystal microstructure orientation throughout as an alternative to more conventional materials featuring greater disorder in their microstructures.

Conventionally, gradient concentration precursors have mainly been used to produce positive electrode active materials having an oriented structure; however, this manner of producing positive electrode active materials could not achieve complete orientation from the interior to the surface of the particles. Furthermore, implementing this approach requires complex processes, resulting in low economic efficiency and difficulty in quality control.

There is a need in the art for a more cost effective way to make positive electrode active material precursors for secondary lithium batteries, where the precursor exhibits a highly uniform oriented microstructure.

The above information disclosed in this Background section is only for understanding of the background of the inventive concepts, and, therefore, it may contain information that does not constitute prior art.

### SUMMARY

Embodiments of the present invention provide a uniformly grown positive electrode active material precursor by adding a colloidal flocculant to the reaction solution from which the precursor is precipitated. This technique enables the manufacture of a positive electrode active material having a high level of microstructural orientation, while ensuring economic efficiency.

Additional features of the inventive concepts will be set forth in the description which follows, and in part will be apparent from the description, or may be learned by practice of the inventive concepts.

In one aspect of the present invention, there is provided a method for manufacturing a positive electrode active material precursor for a lithium secondary battery, the method comprising: preparing a metal raw material; forming a reaction solution comprising the metal raw material; and coprecipitating a metal hydroxide positive electrode active material precursor, wherein the reaction solution further comprises an additive, and wherein the additive comprises a colloidal flocculant.

In some embodiments, the precursor obtained according to the manufacturing method can have lithium migration paths formed radially from a particle center as a result of uniform microcrystalline orientation throughout the particle.

In some embodiments, in the step of preparing the metal raw material, the reaction can be carried out using a single metal raw material without separately preparing a core metal raw material and a shell metal raw material.

In some embodiments, the method can further comprise, after the steps of forming a reaction solution comprising the metal raw material and coprecipitating a metal hydroxide precursor, separating the obtained precursor from waste liquid, wherein the separated waste liquid can be used in place of the additive in a succeeding iteration of the method.

In some embodiments, the method can further comprise, after the steps of forming a reaction solution comprising the metal raw material and coprecipitating a metal hydroxide precursor, separating the obtained precursor from waste liquid, wherein the separated waste liquid can be introduced into the coprecipitation reaction together with the additional additive in a succeeding iteration of the method.

In some embodiments, the waste liquid can comprise Na₂SO₄.

In some embodiments, the colloidal flocculant can comprise an inorganic salt including a cation with a charge of +1 to +3.

In some embodiments, the colloidal flocculant can comprise sodium nitrate, potassium nitrate, ammonium nitrate, sodium sulfate, sodium pyrosulfate, potassium pyrosulfate, ammonium pyrosulfate, potassium sulfate, ammonium sulfate, sodium phosphate, potassium phosphate, ammonium phosphate, sodium pyrophosphate, potassium pyrophosphate, ammonium pyrophosphate, or a combination thereof.

In some embodiments, the colloidal flocculant can reduce a surface charge of nuclei generated during the coprecipitation reaction to cause particle agglomeration.

In some embodiments, the manufactured precursor can be a layered precursor comprising nickel, manganese, and cobalt.

In some embodiments of the inventive method, the waste liquid can comprise Na₂SO₄.

In some embodiments of the inventive method, the forming and coprecipitating steps can be performed simultaneously.

In some embodiments of the inventive method, the forming step can further comprise stirring the reaction solution.

In some embodiments, the stirring speed can be in a range of from 200 rpm to 600 rpm. In particular embodiments, the stirring speed can be about 400 rpm.

In some embodiments of the inventive method, the forming step can further comprise heating the reaction solution. In particular embodiments, the reaction solution can be heated to a range of from about 30° C. to about 50° C.

In some embodiments, the metal raw material can be prepared from a mixture of nickel sulfate, cobalt sulfate and manganese sulfate. In particular embodiments, the molar ratio of nickel sulfate: cobalt sulfate: manganese sulfate can be about 0.88:0.05:0.07.

In some embodiments of the inventive method, the coprecipitating step can be performed at a pH in a range of from about 10.5 to about 11.5.

The present invention relates to a positive electrode active material precursor for a lithium secondary battery having an oriented microstructure and a positive electrode active material manufactured using the same, and, more particularly, to a method for manufacturing an oriented precursor for a lithium secondary battery, which, by virtue of having an oriented microstructure, exhibits long lifespan and high capacity characteristics.

The positive electrode active material precursor for a lithium secondary battery according to the present invention is in the form of particles having an oriented microstructure from the interior to the exterior of the particles, thereby reducing the migration resistance of lithium ions and enabling the manufacture of a secondary battery having high output and long lifespan characteristics.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic diagram illustrating the principle of controlling the degree of aggregation through zeta potential control in a comparative example of an embodiment of the present disclosure.

FIG. 2 is a schematic diagram of the structure of a reactor for manufacturing a conventional core-shell structured precursor and the structure of a reactor according to an embodiment of the present disclosure.

FIG. 3 is an SEM image of positive electrode active material precursors manufactured according to a comparative example and Examples 1 and 2.

FIG. 4 shows plots of battery efficiency (% of initial) versus cycle number for lithium secondary batteries incorporating positive electrode active materials manufactured according to the comparative example and Examples 1 and 2.

FIG. 5 shows plots of voltage versus discharge capacity (mAh/g) for lithium secondary batteries incorporating positive electrode active materials manufactured according to the comparative example and Examples 1 and 2.

FIG. 6 shows plots of discharge capacity (mAh/g) versus discharge rate (C-rate, where 1C means that the battery discharges its full capacity in 1 hour) for lithium secondary batteries incorporating positive electrode active materials manufactured according to the comparative example and Examples 1 and 2.

FIG. 7 shows selected tabulated data corresponding to the plots of FIG. 6.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the present invention will be described in detail. However, these are presented by way of example only, and the present invention is not limited thereto, but is defined only by the scope of the claims set forth below.

In general, transition metal hydroxide positive electrode active material precursor synthesis is carried out in a highly alkalineenvironment, and, due to the coordination bonding characteristics of transition metals, the range of conventionally available additives known to lead to improved precursor materials has been very limited. In the present invention, an additive capable of controlling particle aggregation through zeta potential control was developed and applied to the precursor manufacturing method. As a result, microstructurally oriented precursors and active materials that provide improved battery properties can be manufactured by a method that has never been attempted before.

In general, the surface of a transition metal hydroxide precursor particle carries a negative charge in an aqueous solution due to associated OH⁻ ions, and this is referred to as the zeta potential. The compressed Stern layer (layer of ions adhering to the particle surface) of the precursor moves together with the precursor particle, whereas a diffuse layer of ions moves with the aqueous solution surrounding the particle. In a regime of particle dispersion within an aqueous solution, the zeta potential plays an important role in keeping the particles apart via electrostatic repulsion.

Specifically, the larger the surface charge, the greater the repulsive force between particles, resulting in particle dispersion. Conversely, the smaller the surface charge, the lower the repulsive force between particles, resulting in conditions that can permit aggregation.

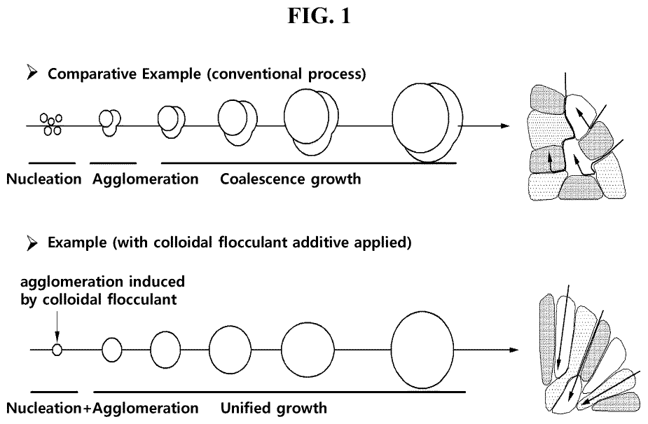

FIG. 1 is a schematic diagram illustrating the principle of controlling the degree of aggregation of particles through zeta potential control in an embodiment of the present disclosure. In an inventive embodiment, agglomeration induced by a colloidal flocculant early in the process of formation of precursor particles can produce microstructure including radially disposed ion channels, whereas if nucleation of particles is predominant at an early particle formation stage as in the comparative example, ion channels extending from the particle surface reach particle interior areas inefficiently if at all.

That is, the present invention can obtain a uniformly grown precursor in which crystal planes are uniformly grown from the interior to the exterior of secondary particles formed of aggregated primary particles, and this effect is derived from the function of the additive used in the coprecipitation step.

In one embodiment of the present invention, there is provided a method for manufacturing a positive electrode active material precursor for a lithium secondary battery, the method comprising: preparing a metal raw material; and forming a reaction solution comprising the metal raw material to coprecipitate a metal hydroxide precursor, wherein the reaction solution further comprises an additional additive, and wherein the additive comprises a colloidal flocculant.

More specifically, the embodiment may comprise: preparing a reaction mother liquor; preparing a metal raw material; and introducing the metal raw material into the reaction mother liquor to form a reaction solution and coprecipitate a metal hydroxide precursor, wherein the reaction solution further comprises an additional additive, and the additive comprises a colloidal flocculant. In some embodiments, the additive may be introduced into the reaction mother liquor in the step of preparing the reaction mother liquor.

As described above, in the precursor manufacturing method according to one embodiment of the present disclosure, an additive comprising a colloidal flocculant for reducing the particle surface zeta potential can be used in the coprecipitation reaction. More specifically, the colloidal flocculant may be an ionically bound inorganic salt.

As a result of including a colloidal flocculant additive in the reaction mixture, uniform particle seeds can be formed due to aggregation of nuclei at the initial stage of the coprecipitation reaction, and a uniformly grown precursor can be manufactured based on the formed seeds.

The precursor obtained according to the manufacturing method may have lithium migration paths formed radially from the particle center, thereby exhibiting orientation. This may be interpreted to mean that the c-axis, which is the lithium migration path, is oriented from the center to the outer periphery. Accordingly, the lithium migration resistance can be reduced, thereby improving the output and lifespan characteristics of the battery.

In addition, the precursor obtained according to the manufacturing method may be a secondary particle formed by aggregation of a plurality of primary particles, and the primary particles may have a plate-like, needle-like, or amorphous particle shape, but are not necessarily limited thereto.

In the step of preparing the metal raw material, the reaction may be carried out using a single metal raw material without separately preparing a core metal raw material and a shell metal raw material. Unlike the prior art, this enables bulk-type precursors to also have orientation.

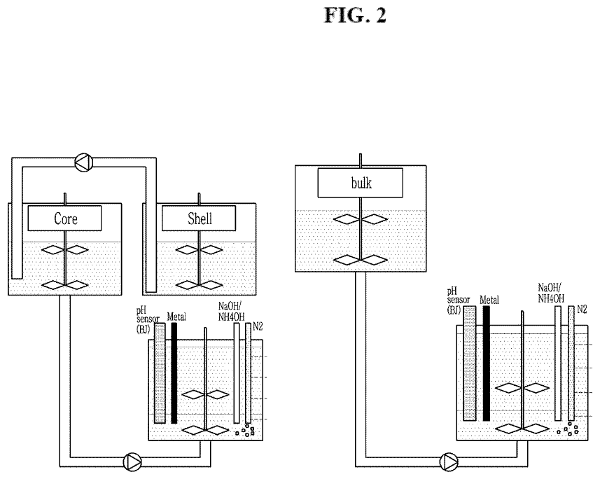

FIG. 2 is a schematic diagram showing the structure of a reactor for manufacturing a conventional core-shell structured precursor and the structure of a reactor according to an embodiment of the present disclosure.

In the related art, in order to obtain orientation, it was necessary to manufacture precursor particles by varying the metal composition of the core and the metal composition of the shell. However, in the precursor manufacturing method employing the additive of the present disclosure, orientation can be achieved without a metal concentration gradient, enabling the manufacture of the precursor in bulk form, thereby providing a price competitiveness advantage.

The method can comprise, after the step of forming a reaction solution comprising the metal raw material to coprecipitate a metal hydroxide precursor, separating the obtained precursor from waste liquid, wherein the separated waste liquid can be used in place of the additive in a succeeding iteration of the method.

Alternatively, the method can comprise, after the step of forming a reaction solution comprising the metal raw material to coprecipitate a metal hydroxide precursor, separating the obtained precursor from waste liquid, wherein the separated waste liquid can be introduced into the coprecipitation reaction together with the additional additive in a succeeding iteration of the method.

The waste liquid may comprise Na₂SO₄. The colloidal flocculant may comprise an inorganic salt including a cation with a charge of +1 to +3.

More specifically, in wastewater after the reaction is complete, by-products such as sodium sulfate in an amount of about 10% by weight may be present. Recycling such wastewater can produce an effect similar to the application of an inorganic salt additive, thus providing an advantage in terms of price competitiveness.

More specifically, the colloidal flocculant may be an inorganic salt, and examples include sodium nitrate, potassium nitrate, ammonium nitrate, sodium sulfate, sodium pyrosulfate, potassium pyrosulfate, ammonium pyrosulfate, potassium sulfate, ammonium sulfate, sodium phosphate, potassium phosphate, ammonium phosphate, sodium pyrophosphate, potassium pyrophosphate, ammonium pyrophosphate, or a combination thereof.

As mentioned above, the colloidal flocculant may be added in the step of preparing the reaction mother liquor prior to the coprecipitation reaction, by introducing the colloidal flocculant into the reaction mother liquor.

The reaction mother liquor may include water, distilled water, deionized water, or a combination thereof, but is not necessarily limited thereto.

The colloidal flocculant may be added in an amount of 3 to 15% by weight, and more specifically, in an amount of 4 to 12% by weight, based on the total weight of the reaction mother liquor. When the amount of the colloidal flocculant satisfies the above range, the aforementioned improvement in precursor orientation and the resulting improvement in battery performance can be more desirably achieved.

Embodiments and comparative examples of the present invention will be described below. However, these embodiments are merely examples of the present invention and are not intended to limit the scope of the invention.

### Examples and Comparative Example

### Example 1: Use of 5% Sodium Sulfate Additive

(Preparation of Reaction Mother Liquor) Water was charged into a 100 L batch reactor in an amount corresponding to 15% of the total reactor volume, and sodium sulfate was introduced into the reactor in an amount of 5 parts by weight per 100 parts by weight of water. While stirring at a speed of 400 rpm, the internal temperature was set to 30-50° C., and nitrogen gas was introduced into the reactor to establish an inert atmosphere.

(Preparation of Raw Materials) Subsequently, a 2.5 M aqueous metal sulfate solution containing nickel sulfate, cobalt sulfate, and manganese sulfate mixed at a molar ratio of 0.88:0.05:0.07, a 25% sodium hydroxide solution, and a 28% ammonia solution were prepared.

(Formation of Reaction Solution and Coprecipitation Reaction) The flow rate of the metal sulfate solution was adjusted to 3 L/h, and the flow rate of the ammonia solution was adjusted to 0.04 times the flow rate of the metal sulfate solution. The amount of sodium hydroxide (NaOH) solution fed into the reactor was controlled so that the hydrogen ion concentration (pH) in the reactor was maintained at about 10.5 to about 11.5, thereby forming a reaction solution and performing a coprecipitation reaction. During the reaction, the stirring speed was maintained at 400 rpm, the average residence time of the total solution was set to 20 hours, the reaction temperature was maintained at 30° C. to 50° C., and nitrogen gas was introduced to maintain an inert atmosphere.

(Washing and Drying) After the reaction was completed, the resulting slurry was washed and subjected to solid-liquid separation using a filter press, and residual moisture was removed using high-pressure fresh air. The separated solids were dried using a fluidized bed dryer at 100° C. to 200° C.

(Calcination) The obtained hydroxide particles were mixed with lithium hydroxide in an equivalent ratio of 1.05 with respect to the hydroxide, and then heated under an oxygen atmosphere at a rate of 2.5° C./min, followed by calcination at 780° C. for 9 hours to produce a lithium composite metal oxide having a uniform oriented structure.

### Example 2: Use of 10% Sodium Sulfate Additive

Except that sodium sulfate was introduced in an amount of 10 parts by weight per 100 parts by weight of water in the preparation of the reaction mother liquor, the procedure was the same as in Example 1 to manufacture the positive electrode active material precursor and the positive electrode active material.

### Comparative Example: No Sodium Sulfate Additive

Except that sodium sulfate was not introduced in the preparation of the reaction mother liquor, the procedure was the same as in Example 1 to manufacture the positive electrode active material precursor and the positive electrode active material.

### Experimental Example 1: SEM Image Evaluation

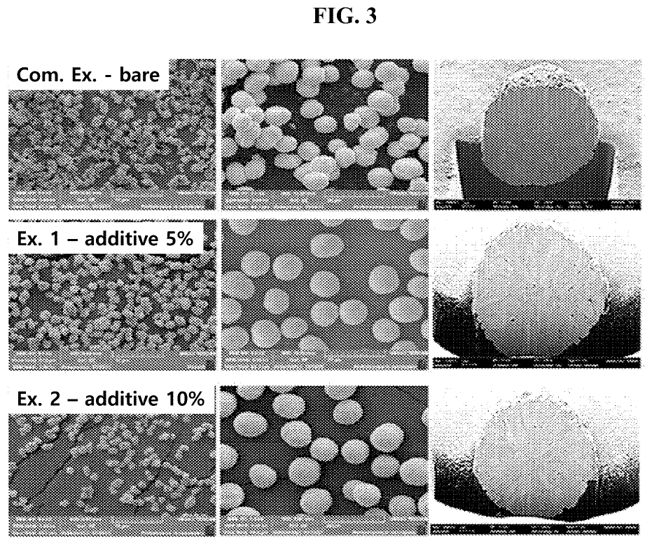

FIG. 3 shows cross-sectional SEM images of the precursors manufactured by the above methods.

SEM analysis revealed that in the comparative example without the additive, particles were not aggregated in the early stage of the reaction and remained dispersed. In the later stage of the reaction, the grown particles merged, resulting in poor sphericity, and cross-sectional analysis confirmed that microcrystalline orientation was not formed in a uniform way.

In contrast, in the examples employing the additive, unit seeds aggregated in the early stage of the reaction, and the final products exhibited significantly improved sphericity. Cross-sectional particle analysis confirmed that a uniform microcrystalline orientation was well formed.

### Experimental Example 2: Evaluation of Electrochemical Properties of Batteries

(Manufacture of Lithium Secondary Battery) For each of Examples 1 and 2 and the Comparative Example, the respective positive electrode active material was mixed with Super C as a conductive agent and PVDF as a binder at a weight ratio of 96.5:1.5:2 to prepare a positive electrode active material slurry. The slurry was uniformly coated onto an aluminum foil with a thickness of 20 μm, and vacuum-dried at 130° C. to fabricate a positive electrode.

Coin cells were assembled using the fabricated positive electrode as the working electrode, lithium foil as the counter electrode, a polypropylene film as the separator, and an electrolyte prepared by dissolving 1.0 M LiPF₆ in an ethylene carbonate/ethyl methyl carbonate/dimethyl carbonate (EC/EMC/DMC) solvent mixture.

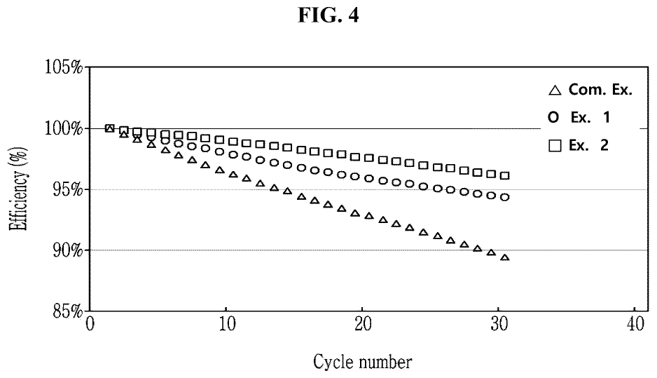

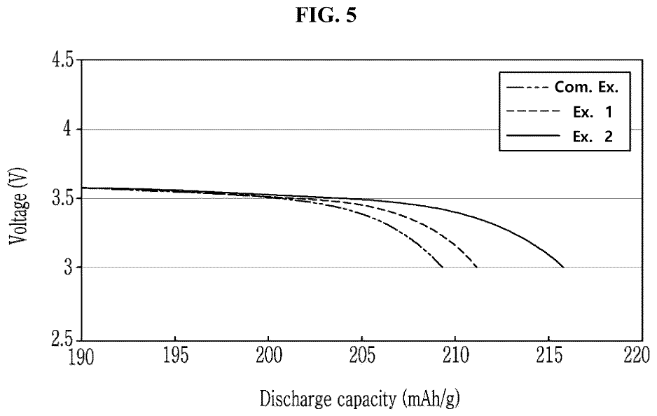

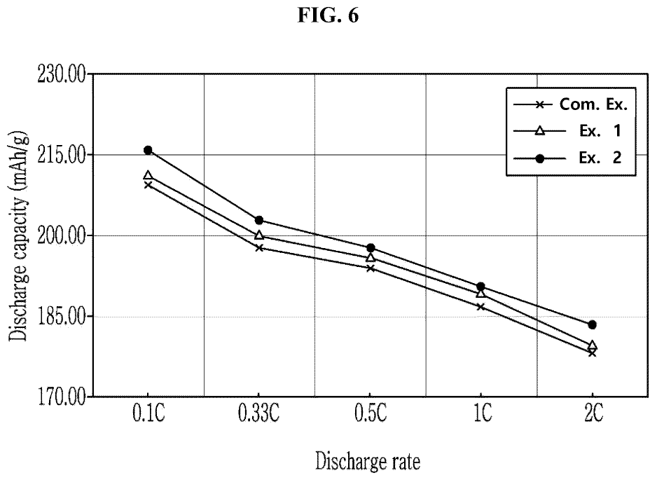

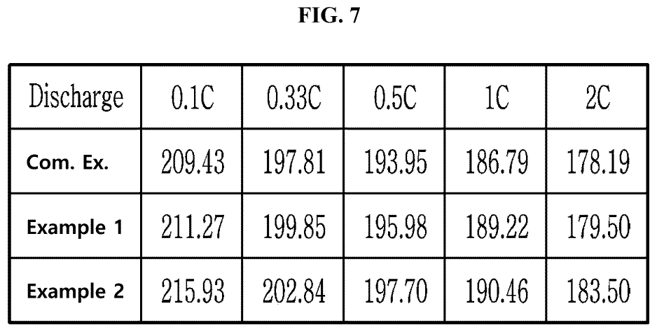

The fabricated lithium secondary batteries were evaluated for charge-discharge efficiency during cycling, initial discharge capacity, and initial discharge capacity at rates of 0.1C, 0.33C, 0.5C, 1C, and 2C. (These units refer to C-rate, where a 1C rate means that the discharge current will discharge the entire battery in 1 hour.) The results are shown in FIGS. 4 to 7.

As shown in FIGS. 4 to 7, in Examples 1 and 2, where an appropriate amount of colloidal flocculant was added, the charge-discharge efficiency during cycling, initial discharge capacity, and high-rate performance were all significantly improved compared to the Comparative Example without the colloidal flocculant. This improvement is interpreted as resulting from enhanced particle aggregation and orientation of the active material, thereby improving battery performance.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A method for manufacturing a positive electrode active material precursor for a lithium secondary battery, the method comprising: preparing a metal raw material; forming a reaction solution comprising the metal raw material; and coprecipitating a metal hydroxide positive electrode active material precursor, wherein the reaction solution further comprises an additive, and wherein the additive comprises a colloidal flocculant.

2. The method for manufacturing a positive electrode active material precursor for a lithium secondary battery of claim 1, wherein the precursor obtained according to the manufacturing method has lithium migration paths formed radially from a particle center as a result of uniform microcrystalline orientation throughout the particle.

3. The method for manufacturing a positive electrode active material precursor for a lithium secondary battery of claim 1, wherein in the step of preparing the metal raw material, the reaction is carried out using a single metal raw material without separately preparing a core metal raw material and a shell metal raw material.

4. The method for manufacturing a positive electrode active material precursor for a lithium secondary battery of claim 1, further comprising, after the steps of forming a reaction solution comprising the metal raw material and coprecipitating a metal hydroxide precursor, separating the obtained precursor from waste liquid, wherein the separated waste liquid is used in place of the additive in a succeeding iteration of the method.

5. The method for manufacturing a positive electrode active material precursor for a lithium secondary battery of claim 1, further comprising, after the steps of forming a reaction solution comprising the metal raw material and coprecipitating a metal hydroxide precursor, separating the obtained precursor from waste liquid, wherein the separated waste liquid is introduced into the coprecipitation reaction together with the additional additive in a succeeding iteration of the method.

6. The method for manufacturing a positive electrode active material precursor for a lithium secondary battery of claim 4, wherein the waste liquid comprises Na₂SO₄.

7. The method for manufacturing a positive electrode active material precursor for a lithium secondary battery of claim 1, wherein the colloidal flocculant comprises an inorganic salt including a cation with a charge of +1 to +3.

8. The method for manufacturing a positive electrode active material precursor for a lithium secondary battery of claim 7, wherein the colloidal flocculant comprises sodium nitrate, potassium nitrate, ammonium nitrate, sodium sulfate, sodium pyrosulfate, potassium pyrosulfate, ammonium pyrosulfate, potassium sulfate, ammonium sulfate, sodium phosphate, potassium phosphate, ammonium phosphate, sodium pyrophosphate, potassium pyrophosphate, ammonium pyrophosphate, or a combination thereof.

9. The method for manufacturing a positive electrode active material precursor for a lithium secondary battery of claim 1, wherein the colloidal flocculant reduces a surface charge of nuclei generated during the coprecipitation reaction to cause particle agglomeration.

10. The method for manufacturing a positive electrode active material precursor for a lithium secondary battery of claim 1, wherein the manufactured precursor is a layered precursor comprising nickel, manganese, and cobalt.

11. The method for manufacturing a positive electrode active material precursor for a lithium secondary battery of claim 5, wherein the waste liquid comprises Na₂SO₄.

12. The method of claim 1, wherein the forming and coprecipitating steps are performed simultaneously.

13. The method of claim 1, the forming step further comprising stirring the reaction solution.

14. The method of claim 13, wherein the stirring speed is in a range of from rpm to 600 rpm.

15. The method of claim 14, wherein the stirring speed is about 400 rpm.

16. The method of claim 1, the forming step further comprising heating the reaction solution.

17. The method of claim 16, wherein the reaction solution is heated to a range of from about 30° C. to about 50° C.

18. The method of claim 1, wherein the metal raw material is prepared from a mixture of nickel sulfate, cobalt sulfate and manganese sulfate.

19. The method of claim 18, wherein the molar ratio of nickel sulfate: cobalt sulfate: manganese sulfate is about 0.88:0.05:0.07.

20. The method of claim 1, wherein the coprecipitating step is performed at a pH in a range of from about 10.5 to about 11.5.
